(19) United States
(12) Patent Application Publication
(10) Pub. No.: US 2009/0107189 A1
(43) Pub. Date: Apr. 30, 2009

(54) FIRE DOOR LOCK

(76) Inventor: CHING-TIEN LIN, Hsin Chuang City (TW)

Correspondence Address: LEONG C LEI, PMB # 1008, 1867 YGNACIO VALLEY ROAD, WALNUT CREEK, CA, 94598, US

(21) Appl. No.: 11/877,677

(22) Filed: Oct. 24, 2007

(51) Int. Cl. E05B 65/10

(52) U.S. Cl. 70/91

(57) ABSTRACT

A fire door lock includes a base assembly including first and second slide blocks, a locking control assembly including a movable seat forming a groove and a tongue control plate movably mounted to one side of the locking control assembly, and a winglet assembly including first and second winglets both having a boss movably received in the groove of the movable seat and both being respectively and rotatably coupled to the first and second slide blocks. Thus, when the movable seat is driven by a handle, the movable seat moves the first and second slide blocks to withdraw first and second latch bars to unlock the fire door and when the fire door is closed, the tongue control plate is actuated to allow the movable seat to return to the locked condition and the first and second latches and a tongue are stretched out to realize three-directional locking.

### BACKGROUND OF THE INVENTION

(a) Technical Field of the Invention

The present invention relates to a fire door lock, and in particular to a fire door lock comprising a movable seat, which when actuated and moved by a handle bar, moves first and second slide blocks and a lock tongue inward to further drive first and second latch bars inwards to unlock the fire door, and which, when the door is closed and a tongue control plate is brought into contact with an external fixture and thus actuated, automatically returns to the original locked position to stretch the first and second latch bars outward to secure the fire door and also cause a tongue holder seat to abut against and maintain the tongue in the locked condition thereby realizing a three-directional locking of the fire door.

(b) Description of the Prior Art

Fire door locking mechanisms are known, such as Taiwan Patent Publication No. 568161, which discloses in FIG. 11 of the attached drawings thereof a central locking mechanism 3 and upper and lower locking mechanisms 4, 6 that are coupled to the central locking mechanism 3, and a transmission mechanism 9 that is coupled to the central locking mechanism 3 so that when an operating handle bar is depressed, the transmission mechanism 9 drives the central locking mechanism 3, which in turn drives the upper and lower locking mechanisms 4, 6 to operate in a simultaneous manner for locking and unlocking a fire door.

The conventional device, although effective in overcoming the drawback of other known fire door mechanism that no upper and lower vertical latching are included. However, such a conventional device does not include horizontal latching or locking so that when the fire door can be broken in by breaking a middle portion of the door. Thus, further improvement is needed.

Other prior art references, such as U.S. Pat. No. 7,144,050, suffer the same drawback.

Thus, it is desired to provide an improved fire door lock that enhances security of the fire door, while maintaining easy operation by a user to open the door.

### SUMMARY OF THE INVENTION

The primary purpose of the present invention is to provide a fire door lock comprising a base assembly, which comprises a bottom plate on which first and second slide blocks are slidably mounted, a locking control assembly, which comprises a movable seat forming a groove and a tongue control plate movably mounted to one side of the locking control assembly, and a winglet assembly, which comprises first and second winglets, which both have a boss movably received in the groove of the movable seat and both being respectively and rotatably coupled to the first and second slide blocks. Thus, when the movable seat is driven by an operating handle bar, the movable seat is driven to move the first and second slide blocks to withdraw first and second latch bars to thereby unlock the fire door. When the fire door is closed, the tongue control plate is hit and acted to allow the movable seat to return to the locked condition and the first and second latches and a tongue are stretched out to realize three-directional locking.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a fire door lock constructed in accordance with the present invention;

FIG. 2 is an exploded view of the fire door lock of the present invention;

FIG. 3 is an exploded view of a base assembly of the fire door lock of the present invention;

FIG. 4 is an exploded view of a locking control assembly of the fire door lock of the present invention;

FIG. 5 is a perspective view, partially broken, of the locking control assembly of the fire door lock of the present invention;

FIG. 6 is a schematic view illustrating the base assembly before the fire door lock is operated;

FIG. 7 is a side elevational view of the locking control assembly before the fire door lock is operated;

FIG. 8 is a cross-sectional view of the locking control assembly before the fire door lock is operated;

FIG. 9 is a perspective view illustrating the operation of the fire door lock of the present invention;

FIG. 10 is a schematic view illustrating the base assembly after the fire door lock is operated;

FIG. 11 is a side elevational view of the locking control assembly after the fire door lock is operated;

FIG. 12 is a cross-sectional view of the locking control assembly after the fire door lock is operated; and

FIG. 13 is a perspective view illustrating the fire door lock of the present invention mounted to a fire door panel.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

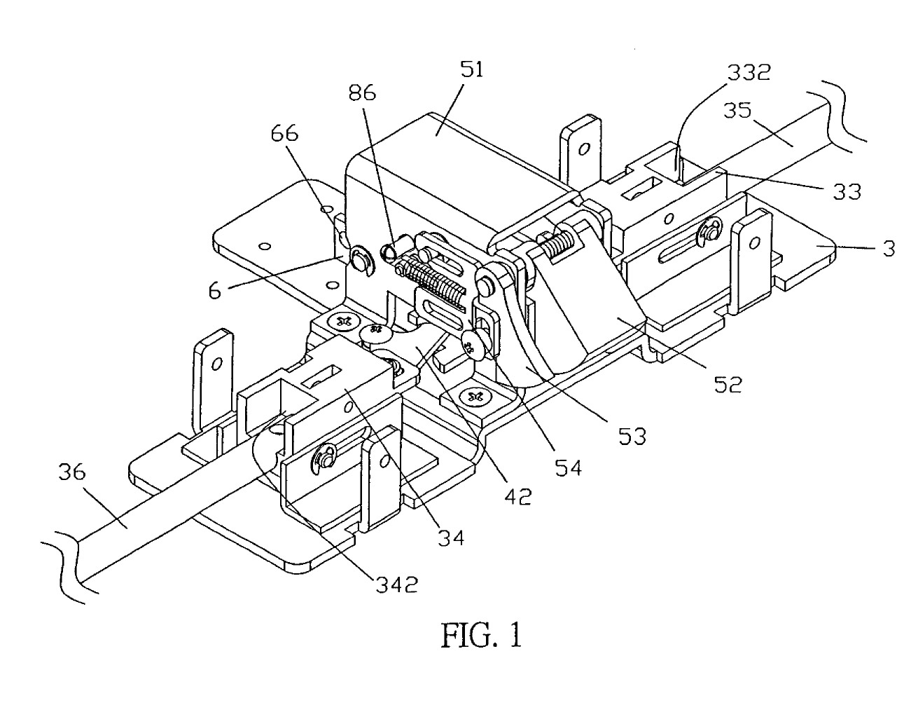

With reference to the drawings and in particular to FIGS. 1-3, a fire door lock constructed in accordance with the present invention comprises a base assembly 2, which comprises a bottom plate 3 and first and second latch bars 35, 36. The bottom plate 3 forms at least one fixing hole 38 and two mounting holes 391, 392, which will be referred to as fifth and sixth mounting holes, respectively. The bottom plate 3 also forms first and second slide racks 31, 23 and comprises first and second slide blocks 33, 34, which are respectively and slidably received in the first and second slide racks 31, 32. The first slide block 33 forms a first notch 332 and a first slot 331 and similarly, the second slide block 34 forms a second notch 342 and a second slot 341. The first latch bar 35 is securely coupled to the first notch 332 of the first slide block 33, while the second latch bar 36 is securely coupled to the second notch 342 of the second slide block 34.

A winglet assembly 4 comprises first and second winglets 41, 42. The first winglet 41 forms first and second mounting holes 45, 46 and a first boss 43. The first mounting hole 45 is rotatably coupled to the fifth mounting hole 391 of the bottom plate 3 by a pivot (not labeled) and the second mounting holes 46 is rotatably coupled to the first slot 331 of the first slide block 33 by a pivot (not labeled). The second winglet 42 forms third and fourth mounting holes 47, 48 and a second boss 44. The third mounting hole 47 is rotatably coupled to the sixth mounting hole 392 of the bottom plate 3 by a pivot (not labeled) and the fourth mounting holes 48 is rotatably coupled to the second slot 341 of the second slide block 34.

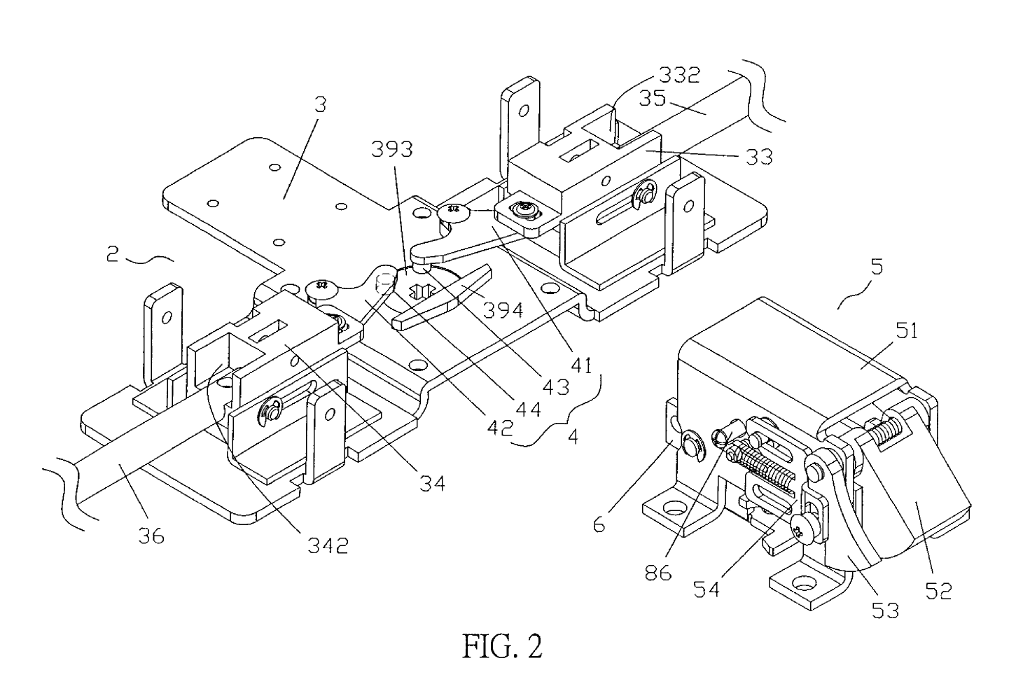

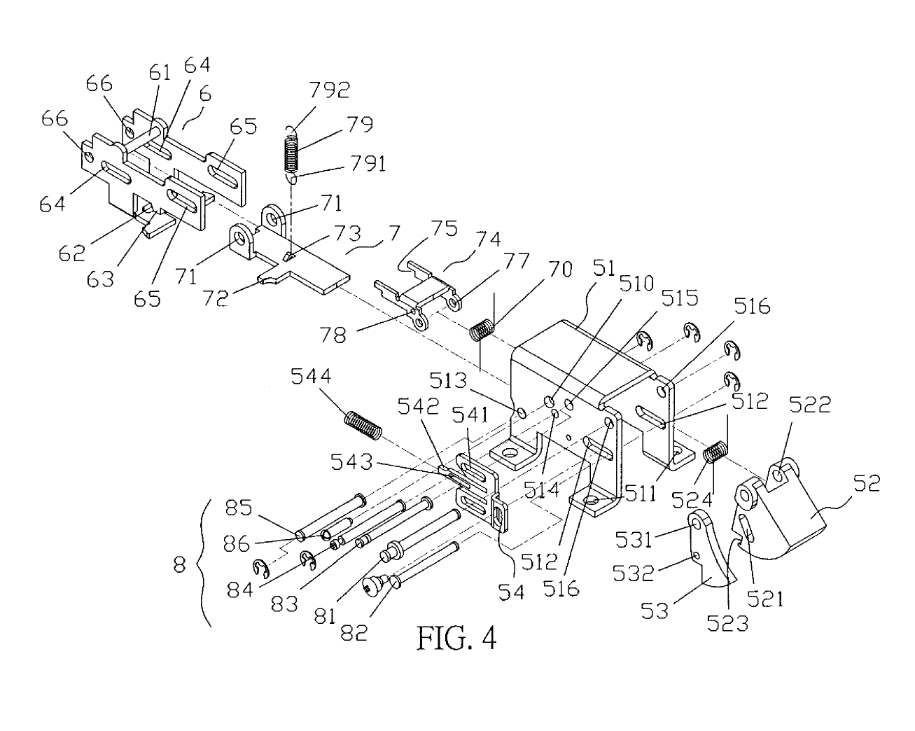

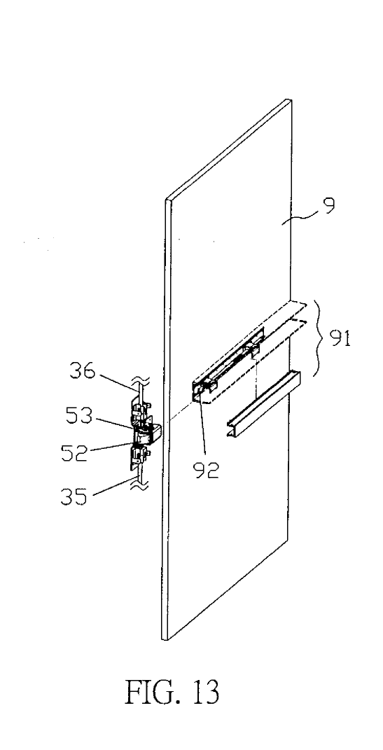

Also referring to FIGS. 2, 4 and 5, a locking control assembly 5 comprises a housing 51, a movable seat 6, a tongue holder seat 7, a holder 74 and a tongue 52, a tongue control plate 53, a control plate 54, and a shaft set 8 that is composed of a number of pins and shafts 81-85. The housing 51 forms at least one housing mounting hole 511, a control hole 510, a third elongated hole 512 and fourth, fifth, sixth, and seventh through-holes 513, 514, 515, 516. The movable seat 6 comprises a positioning bar 61, a first stop 63, a groove 62, and at least one through hole 66. The movable seat 6 has opposite side walls in which first elongated holes 64 and second elongated holes 65 are formed. The through holes 66 function to couple a connection end 92 of an operating handle assembly 91, as shown in FIG. 13. The tongue holder seat 7 comprises a second stop 72, first through holes 71, an anchoring hole 73, and a third spring 79. The holder 74 forms holding sections 75, a first aperture 78 and second trough holes 77. The tongue 52 forms a (recessed) engaging portion 523, a first bore 521, and second bores 522. The tongue control plate 53 has a third trough holes 531 and a second aperture 532. The control plate 54 comprises a fourth spring 544, a third stop 542, a fourth elongated hole 541, and a fifth elongated hole 543. The pivot set 8 comprises a control pin 86, a first shaft 81, a second shaft 82, a third shaft 83, a fourth shaft 84, and a fifth shaft 85.

Also referring to FIG. 13, which illustrates the fire door lock of the present invention mounted to a fire door panel 9, the connection end 92 of the operating handle assembly 91 is coupled to the trough holes 66 of the movable seat 6 so that when the operating handle assembly 91 is depressed or actuated, the first and second latch bard 35, 36 and the tongue 52 are moved to allow the fire door 9 to open. Further, when the fire door 9 is being closed the tongue control plate 53 is brought into contact with for example a door frame or a fixed article, the movable seat 6 is released to return to the original locked position whereby the first and second latch bars 35, 36 secure the fire door 9 and the tongue holder seat 7 is put in abutting engagement with the engaging portion 523 of the tongue 52 to thereby realize securing the fire door at three different orientations.

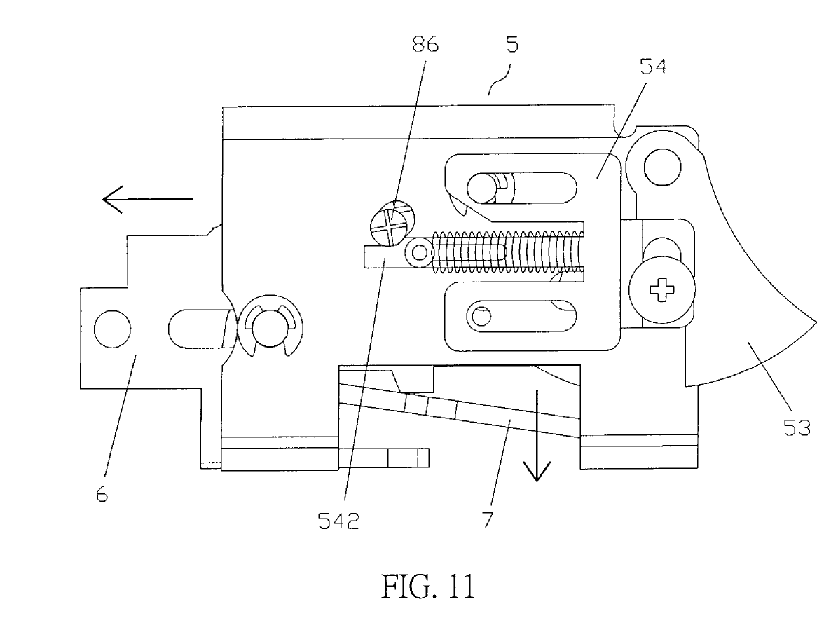

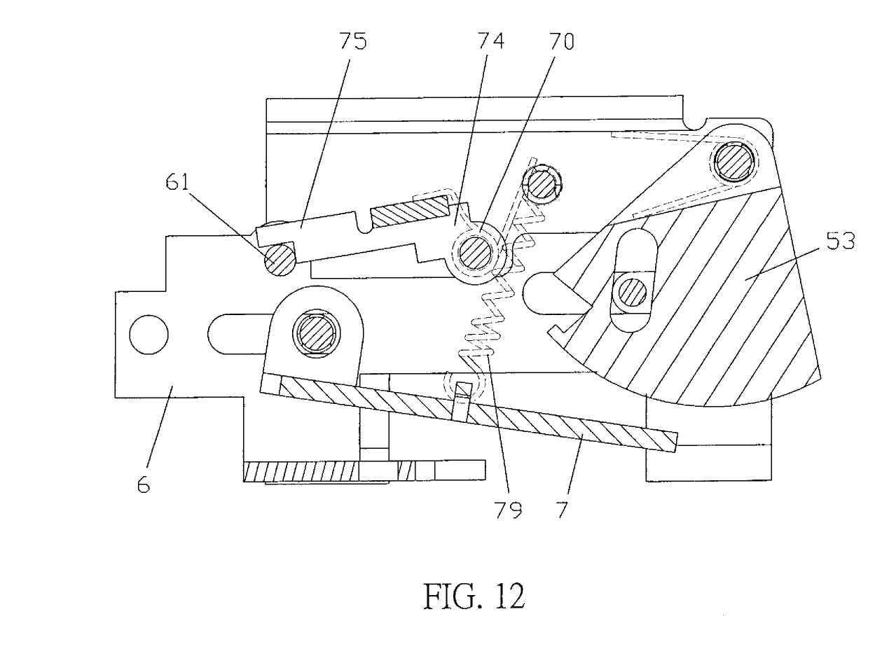

The first shaft 81 is received in the seventh through hole 516 of the housing 51 and is also rotatably fit into the third through hole 531 of the tongue control plate 53 and the second bores 522 of the tongue 52, and also extends through the first spring 524, which is a helical spring in the embodiment illustrated to thereby mount the tongue control plate 53, the tongue 52, and the first spring 524 in the housing 51. The second shaft 82 is movably received in the third elongated holes 512 of the housing 51 and is movably fit into the second elongated holes 65 of the movable seat 6 and the first bore 521 of the tongue 52 to thereby mount the movable seat 6 and the tongue 52 in the housing 51. Thus, when the movable seat 6 is moved in a rearward direction (that is a direction away from the tongue 52) by being actuated by the operating handle assembly 91, the tongue 52 is moved into the housing 51 and at the same time, the first stop 63 of the movable seat 6 depresses the second stop 72 of the tongue holder seat 7 downward (as illustrated in FIG. 11) due to a camming engagement therebetween to thereby release the abutting engagement between the tongue holder seat 7 and the engaging portion 523 of the tongue 52. By this, the tongue 52 is allowed to move inward into the housing 51 as demonstrated in FIG. 12. Further, the second spring 70 biases the holder 74 in such a way that the holding sections 75 of the holder 74 are moved into engagement with the positioning bar 61 of the movable seat 6 to prevent the movable seat 6 from moving forward and thereby maintaining an unlocked condition.

The fifth shaft 85 is received in the fourth through holes 513 of the housing 51 and is movably fit into the first elongated holes 64 of the movable seat 6 and rotatably fit into the first through holes 71 of the tongue holder seat 7 to thereby mount the movable seat 6 and the tongue holder seat 7 in the housing 51. The third shaft 83 is received in the sixth rough hole 515 of the housing 51 and is movably fit into the fourth elongated hole 541 of the control plate 54 to mount the control plate 54 to an outside surfaced of one side wall of the housing 51. The fourth shaft 84 is received in the fifth through holes 514 of the housing 51 and is rotatably fit in the second trough holes 77 of the holder 74 and also extends through the second spring 70 and the fifth elongated hole 543 of the control plate 54 to thereby mount the holder 74, the second spring 74, and the control plate 54 to the housing 51. The control pin 86 is fit into the control hole 510 of the housing 51 and is further fit into the first aperture 78 of the holder 74. The third spring 79 has an end 791 mounted to the anchoring hole 73 of the tongue holder seat 7 and an opposite end 792 attached to the third shaft 83.

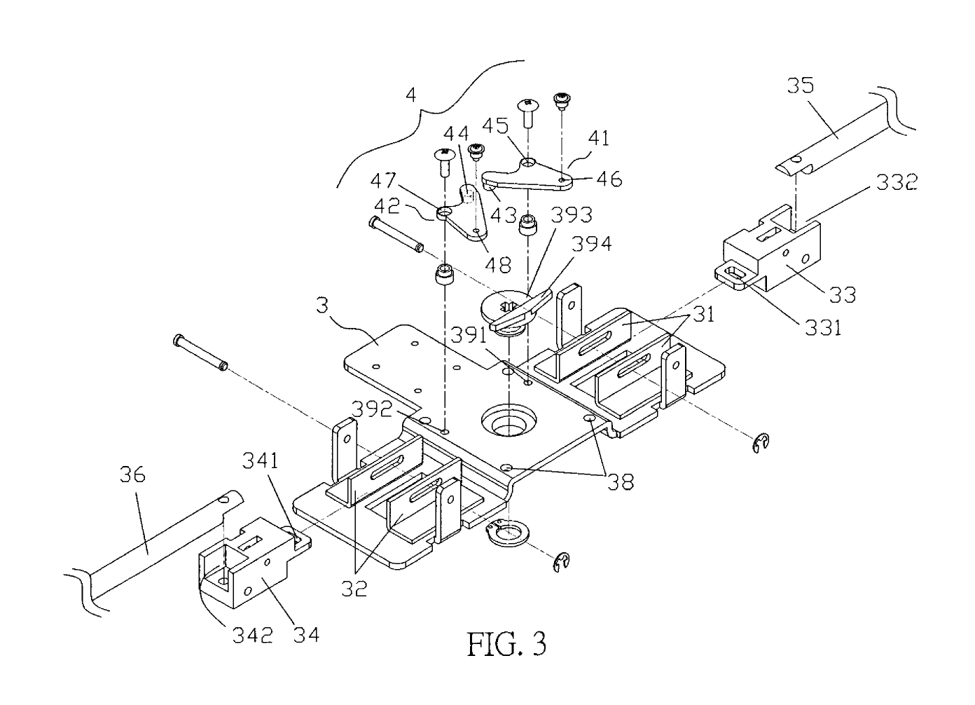

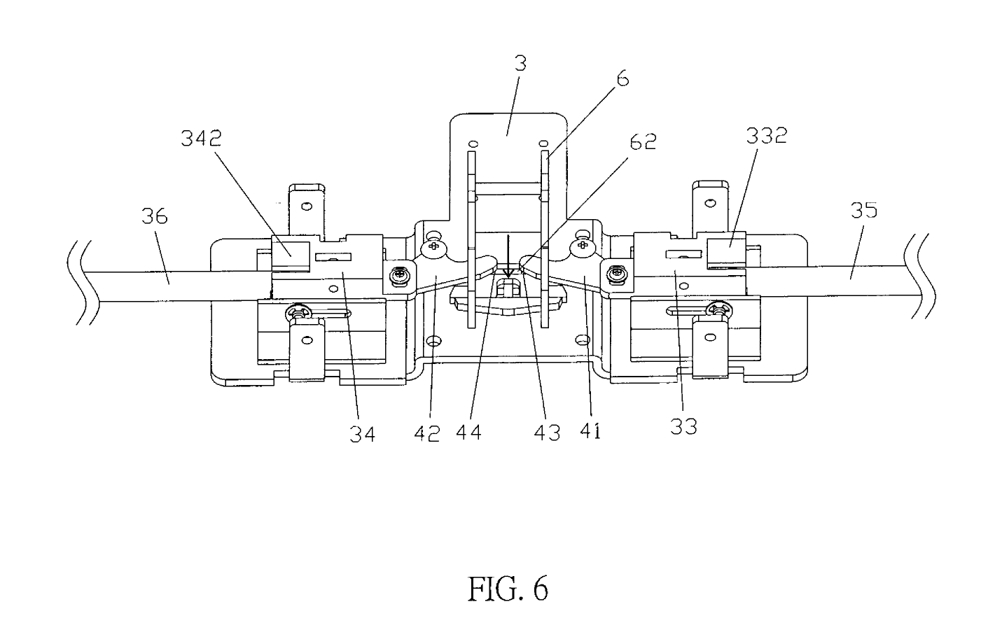

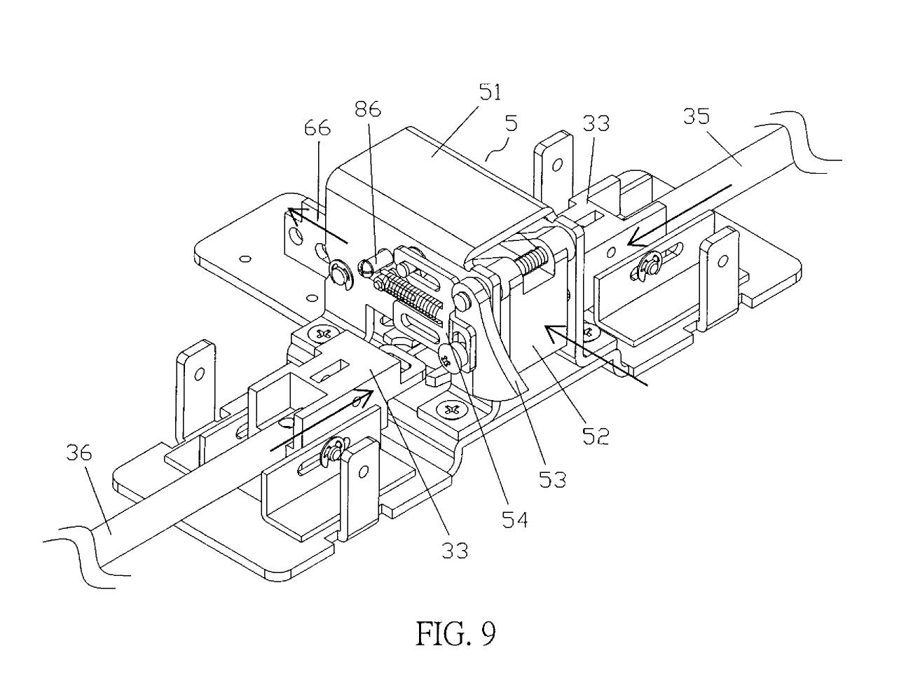

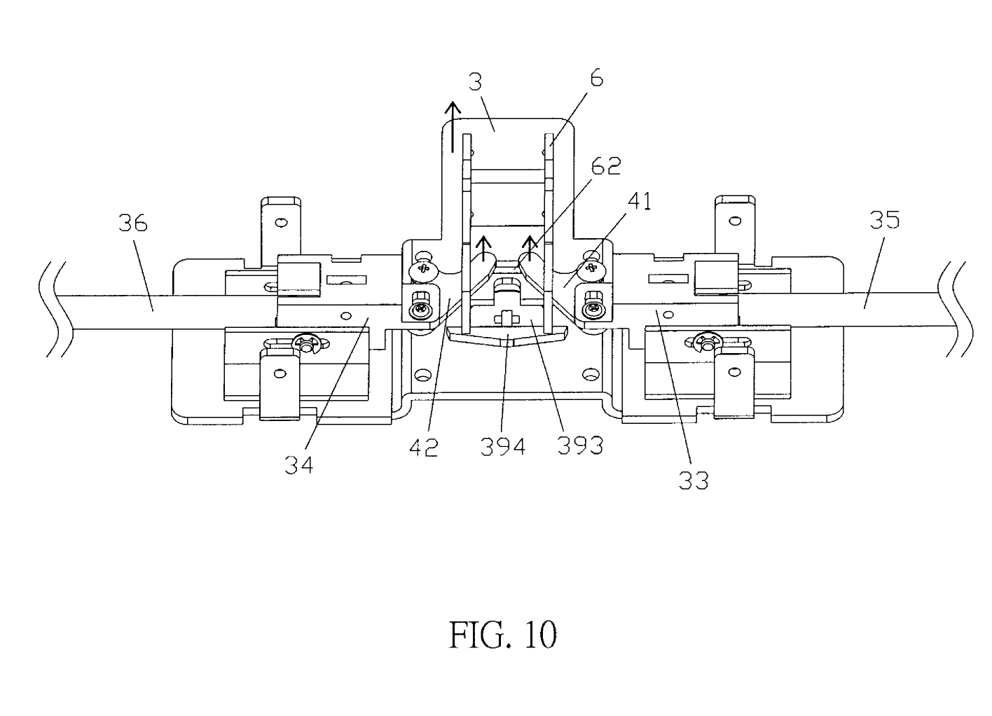

Also referring to FIGS. 3 and 6, the first boss 43 of the first winglet 41 and the second boss 44 of the second winglet 42 are received in the groove 62 of the movable seat 6. The first mounting hole 45 of the first winglet 41 is rotatably coupled to the fifth mounting hole 391 of the bottom plate 3 and the second mounting hole 46 of the first winglet 41 is rotatably and movably coupled to the first slot 331 of the first slide block 33. The third mounting hole 47 of the second winglet 47 is rotatably coupled to the sixth mounting hole 392 of the bottom plate 3 and the fourth mounting hole 48 of the second winglet 42 is movably and rotatably coupled to the second slot 341 of the second slide block 34. Thus, when the movable seat 6 is moved rearward, the first and second slide blocks 33, 34 are driven in a direction into the locking control assembly 5. And as shown in FIGS. 9 and 10, the first and second latch bars 35, 36 are also driven to release the fire door 9. Consequently, both latch bars 35, 36 and the tongue 52 are actuated or moved at the same time to release the fire door 9.

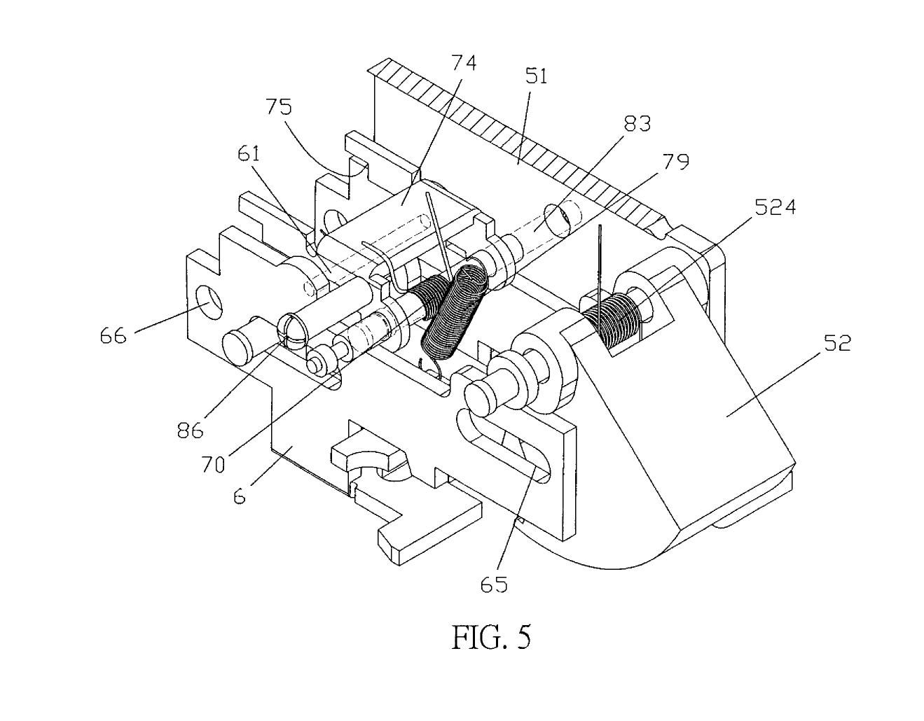

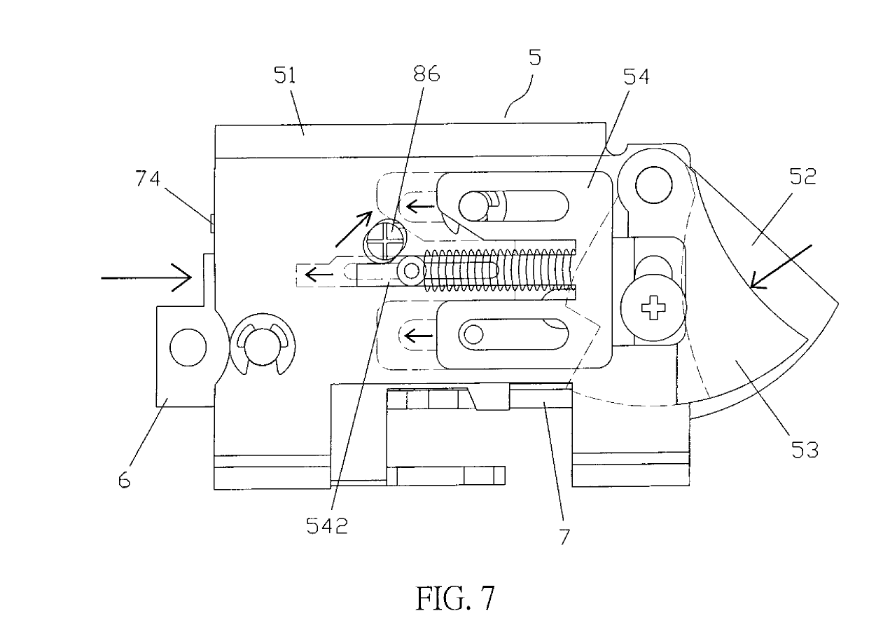

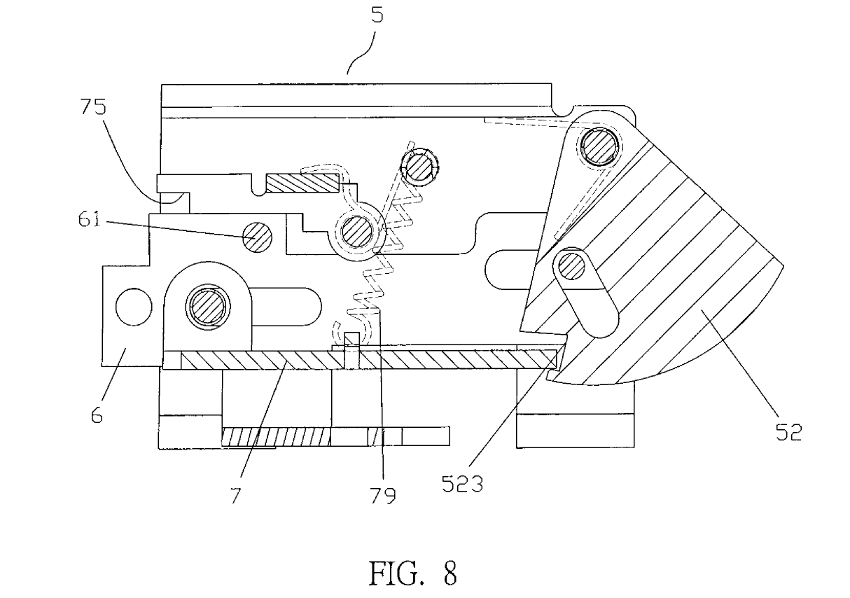

When the fire door 9 is closed again, as shown in FIGS. 5 and 7, the tongue control plate 53 that is movably arranged outside the housing 51 is brought into contact with and thus stopped by for example a door frame or an opposite door panel so that the control plate 54 is forced rearward, the third stop 542 of the control plate 54, due to camming action, raises the control pin 86 upward and simultaneously raises the holder 74 upward thereby releasing the engagement between the holding sections 75 of the holder 74 and the positioning bar 61 of the movable seat 6 to allow the movable seat 6 to return to the locked condition as being biased by a spring force of the third spring 79 that has the end 791 fixed to the anchoring hole 73 of the tongue holder seat 7 and the opposite end 792 attached to the third shaft 83, as shown in FIGS. 5 and 8. In this condition, the tongue holder seat 7 is again positioned in engagement with the recessed engaging portion 523 of the tongue 52 and at the same time, the tongue 52 is biased outward by the first spring 524, to thereby make and maintain the tongue 52 in the locked condition.

In addition, as shown in FIG. 2, the bottom plate 3 is provided with a lock portion 393, which comprises a switching block 394 so that when the lock portion 393 is operated with a key for opening the fire door lock, the switching block 394 is rotated and thus moving the movable seat 6, as shown in FIG. 10, thereby realizing opening of the fire door with a key. Since the lock portion 393 is known in the art and constitutes no novel part of the invention, no detail will be given herein.

Although the present invention has been described with reference to the preferred embodiment thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fire door lock comprising:
a base assembly comprising a bottom plate forming at least one fixing hole, and additionally forming a fifth mounting hole and a sixth mounting hole, the bottom plate also forming first and second slide racks and comprising first and second slide blocks, the first slide block forming a first slot and the second slide block forming a second slot;
a locking control assembly comprising a housing, a movable seat, a tongue holder seat, a holder and a tongue, a tongue control plate, a control plate, and a shaft set, the housing forming at least one housing mounting hole, a fourth through hole, a fifth through hole, and a seventh through hole, the housing mounting hole of the housing being mounted to the fixing hole of the bottom plate, the movable seat forming a groove, the movable seat having opposite side walls in which first elongated holes are defined, the tongue holder seat forming a first through hole, the holder forming a second through hole, the tongue forming a second bore, the tongue control plate forming a third through hole, the control plate forming a fourth elongated hole, the shaft set comprising a first shaft, a third shaft, and a fifth shaft, the first shaft extending trough the seventh trough hole and the second bore of the tongue and the third through hole of the tongue control plate, the third shaft extending through the fifth trough hole of the housing and the second through hole of the holder, and the fifth shaft extending through the fourth through hole of the housing and the first elongated hole of the movable seat and the first rough hole of the tongue holder seat;
a winglet assembly comprising first and second winglet, the first winglet forming first and second mounting holes and a first boss, the first mounting hole being rotatably coupled to the fifth mounting hole of the bottom plate, the second mounting hole being rotatably and movably coupled to the first slot of the first slide block, the second winglet forming third and fourth mounting holes and a second boss, the third mounting hole being rotatably coupled to the sixth mounting hole of the bottom plate, the fourth mounting hole being rotatably and movably coupled to the second slot of the second slide block, the first and second bosses being received in and coupled to the groove of the movable seat.

2. The fire door lock as claimed in claim 1, wherein the base assembly comprises first and second latch bars.

3. The fire door lock as claimed in claim 1, wherein the first slide block forms a first notch.

4. The fire door lock as claimed in claim 1, wherein the second slide block forms a second notch.

5. The fire door lock as claimed in claim 1, wherein the base assembly comprises a lock portion, which comprises a switching block.

6. The fire door lock as claimed in claim 1, wherein the housing forms a control hole, a sixth through hole, and a third elongated hole.

7. The fire door lock as claimed in claim 1, wherein the movable seat forms at least one through hole, a positioning bar, and a first stop, the movable seat further forming second elongated holes in the side walls thereof.

8. The fire door lock as claimed in claim 1, wherein the tongue holder seat forms a second stop and an anchoring hole.

9. The fire door lock as claimed in claim 1, wherein the holder forms a holding section and a first aperture, and comprising a third spring.

10. The fire door lock as claimed in claim 1, wherein the tongue forms a first bore and an engaging portion.

11. The fire door lock as claimed in claim 1, wherein the tongue control plate forms a second aperture.

12. The fire door lock as claimed in claim 1, wherein the control plate forms a fifth elongated hole and comprises a fourth spring and a third stop, the third stop being forming an inclined edge.

13. The fire door lock as claimed in claim 1, wherein the shaft set further comprises a second shaft, a fourth shaft, and a control pin.
